(19) United States
(12) Patent Application Publication
(10) Pub. No.: US 2021/0152639 A1
(43) Pub. Date: May 20, 2021

(54) VEHICLE NETWORK USING PUBLISH-SUBSCRIBE PROTOCOL

(71) Applicant: FORD GLOBAL TECHNOLOGIES, LLC, Dearborn, MI (US)

(72) Inventor: Thomas MADDEN, Plymouth, MI (US)

(21) Appl. No.: 16/684,849

(22) Filed: Nov. 15, 2019

(51) Int. Cl. H04L 29/08; H04L 12/66; H04W 4/44

(52) U.S. Cl. CPC H04L 67/12; H04L 12/66; H04W 84/042; H04L 67/26; H04W 4/44

(57) ABSTRACT

A vehicle includes a human-machine interface (HMI) controller configured to provide an in-vehicle HMI; an electronic control unit (ECU), configured to control a vehicle operation; and a gateway controller connected to the HMI controller and to the ECU via an in-vehicle network, the gateway controller configured to responsive to receiving a request to subscribe to a topic from the HMI controller, subscribe the HMI controller to the topic, responsive to receiving a message in a first format sent from the ECU via the in-vehicle network, convert the message into a second format and process the message to identify a message topic associated with the message, publish the message to the message topic, and responsive to verifying the HMI controller is subscribed to the message topic, send the message in the second format to the HMI controller.

### TECHNICAL FIELD

The present disclosure generally relates to a vehicle network. More specifically, the present disclosure relates to a vehicle network using publish-subscribe network protocol.

### BACKGROUND

Modern vehicles include many electronic controllers configured to provide a variety of functions. Communication between those controllers may be enabled via a vehicle network, such as a controlled area network (CAN). For instance, a vehicle human-machine interface (HMI) may be used to interact with the vehicle by communicating with various underlying vehicle controllers over the vehicle network. A full-featured HMI may handle thousands different signals to and from various controllers performing different operations. Signals communicated via the vehicle network may include direct CAN messages and/or or CAN messages with packed binary data structures as message payloads.

### SUMMARY

In one or more illustrative embodiments of the present disclosure, a vehicle includes a human-machine interface (HMI) controller configured to provide an in-vehicle HMI; an electronic control unit (ECU), configured to control a vehicle operation; and a gateway controller connected to the HMI controller and to the ECU via an in-vehicle network, the gateway controller configured to responsive to receiving a request to subscribe to a topic from the HMI controller, subscribe the HMI controller to the topic, responsive to receiving a message in a first format sent from the ECU via the in-vehicle network, convert the message into a second format and process the message to identify a message topic associated with the message, publish the message to the message topic, and responsive to verifying the HMI controller is subscribed to the message topic, send the message in the second format to the HMI controller.

In one or more illustrative embodiments of the present disclosure, a method for a vehicle includes responsive to receiving a request for subscribing to a user topic from a user client, associating the user client with the user topic; responsive to detecting a message in a first format published by a vehicle service onto an in-vehicle network, converting the message into a second format via a gateway client; processing the message in the second format to identify a message topic via a broker using MQ telemetry transport (MQTT) protocol; and responsive to verifying the user topic matches message topic, send the message in the second format to the user client.

In one or more illustrative embodiments of the present disclosure, a non-transitory computer-readable storage medium includes instructions, when executed by processor of a vehicle, make the vehicle to responsive to receiving a request for subscribing to a topic from a human-machine interface (HMI) controller, subscribe the HMI controller to the topic, responsive to receiving a message in a first format published from an electronic control unit (ECU) via an in-vehicle network, convert the message into a second format and process the message to identify a message topic associated with the message, responsive to verifying the topic the HMI controller subscribed to matches the message topic, send the message in the second format to the HMI controller, and send the message in the second format to a mobile device via a wireless link.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle system of one embodiment of the present disclosure;

FIG. 2 illustrates an example block diagram of a vehicle communication system of one embodiment of the present disclosure; and

FIG. 3 illustrates an example flow diagram of the vehicle communication system of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices, such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a vehicle network with publish-subscribe communication protocol. More specifically, the present disclosure proposes a vehicle network using the MQ telemetry transport (MQTT) protocol to define an interface between a HMI of the vehicle and other controllers of the vehicle.

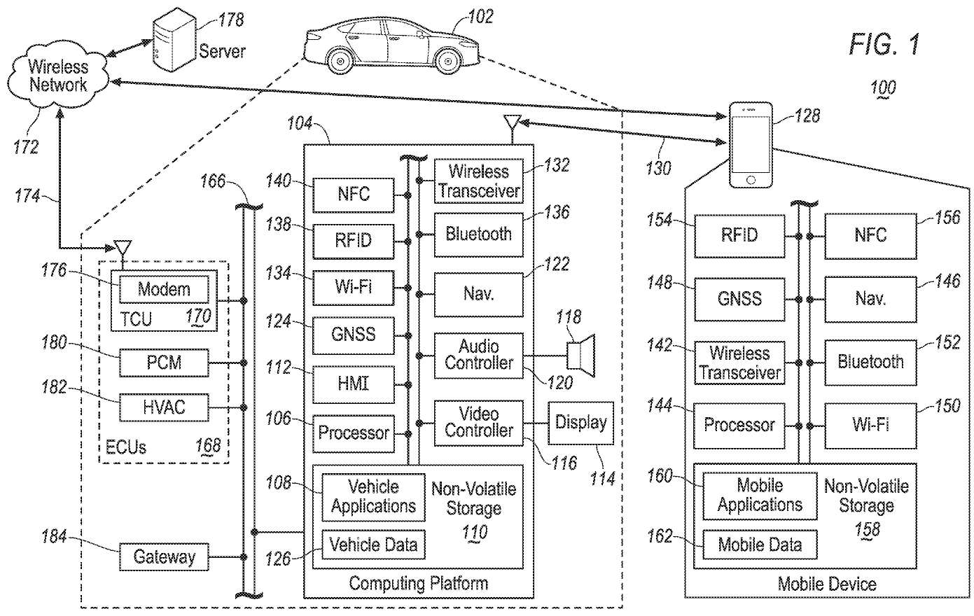

Referring to FIG. 1, an example block topology of a vehicle system 100 of one embodiment of the present disclosure is illustrated. A vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a battery electric vehicle (BEV), a hybrid electric vehicle (HEV) powered by both an internal combustion engine and one or move electric motors, such as a series hybrid electric vehicle (SHEV), a plug-in hybrid electric vehicle (PHEV), or a parallel/series hybrid vehicle (PSHEV), a boat, a plane or other mobile machine for transporting people or goods. As an example, the system 100 may include the SYNC system manufactured by The Ford Motor Company of Dearborn, Mich. It should be noted that the illustrated system 100 is merely an example, and more, fewer, and/or differently located elements may be used.

As illustrated in FIG. 1, a computing platform 104 may include one or more processors 106 configured to perform instructions, commands, and other routines in support of the processes described herein. For instance, the computing platform 104 may be configured to execute instructions of vehicle applications 108 to provide features such as navigation, remote controls, and wireless communications. Such instructions and other data may be maintained in a non-volatile manner using a variety of types of computer-readable storage medium 110. The computer-readable medium 110 (also referred to as a processor-readable medium or storage) includes any non-transitory medium (e.g., tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants/users to interface with the computing platform 104. For example, the computing platform 104 may receive input from HMI controls 112 configured to provide for occupant interaction with the vehicle 102. As an example, the computing platform 104 may interface with one or more buttons, switches, knobs, or other HMI controls configured to invoke functions on the computing platform 104 (e.g., steering wheel audio buttons, a push-to-talk button, instrument panel controls, etc.).

The computing platform 104 may also drive or otherwise communicate with one or more displays 114 configured to provide visual output to vehicle occupants by way of a video controller 116. In some cases, the display 114 may be a touch screen further configured to receive user touch input via the video controller 116, while in other cases the display 114 may be a display only, without touch input capabilities. The computing platform 104 may also drive or otherwise communicate with one or more speakers 118 configured to provide audio output and input to vehicle occupants by way of an audio controller 120.

The computing platform 104 may also be provided with navigation and route planning features through a navigation controller 122 configured to calculate navigation routes responsive to user input via e.g., the HMI controls 112, and output planned routes and instructions via the speaker 118 and the display 114. Location data that is needed for navigation may be collected from a global navigation satellite system (GNSS) controller 124 configured to communicate with multiple satellites and calculate the location of the vehicle 102. The GNSS controller 124 may be configured to support various current and/or future global or regional location systems such as global positioning system (GPS), Galileo, Beidou, Global Navigation Satellite System (GLONASS) and the like. Map data used for route planning may be stored in the storage 110 as a part of the vehicle data 126. Navigation software may be stored in the storage 110 as one the vehicle applications 108.

The computing platform 104 may be configured to wirelessly communicate with a mobile device 128 of the vehicle users/occupants via a wireless connection 130. The mobile device 128 may be any of various types of portable computing devices, such as cellular phones, tablet computers, wearable devices, smart watches, smart fobs, laptop computers, portable music players, or other device capable of communication with the computing platform 104. A wireless transceiver 132 may be in communication with a Wi-Fi controller 134, a Bluetooth controller 136, a radio-frequency identification (RFID) controller 138, a near-field communication (NFC) controller 140, and other controllers such as a Zigbee transceiver, an IrDA transceiver, a ultra-wide band (UWB) controller (not shown), and configured to communicate with a compatible wireless transceiver 142 of the mobile device 128.

The mobile device 128 may be provided with a processor 144 configured to perform instructions, commands, and other routines in support of the processes such as navigation, telephone, wireless communication, and multi-media processing. For instance, the mobile device 128 may be provided with location and navigation functions via a navigation controller 146 and a GNSS controller 148. The mobile device 128 may be provided with a wireless transceiver 142 in communication with a Wi-Fi controller 150, a Bluetooth controller 152, a RFID controller 154, an NFC controller 156, and other controllers (not shown), configured to communicate with the wireless transceiver 132 of the computing platform 104. The mobile device 128 may be further provided with a non-volatile storage 158 to store various mobile application 160 and mobile data 162.

The computing platform 104 may be further configured to communicate with various components of the vehicle 102 via one or more in-vehicle network 166. The in-vehicle network 166 may include, but is not limited to, one or more of a controller area network (CAN), an Ethernet network, and a media-oriented system transport (MOST), as some examples. Furthermore, the in-vehicle network 166, or portions of the in-vehicle network 166, may be a wireless network accomplished via Bluetooth low-energy (BLE), Wi-Fi, UWB, or the like.

The computing platform 104 may be configured to communicate with various ECUs 168 of the vehicle 102 configured to perform various options. For instance, the computing platform 104 may be configured to communicate with a TCU 170 configured to control telecommunication between vehicle 102 and a wireless network 172 through a wireless connection 174 using a modem 176. The wireless connection 174 may be in the form of various communication network e.g., a cellular network. Through the wireless network 172, the vehicle may access one or more servers 178 to access various content for various purposes. It is noted that the terms wireless network and server are used as general terms in the present disclosure and may include any computing network involving carriers, router, computers, controllers or the like configured to store data and perform data processing functions and facilitate communication between various entities. The ECUs 168 may further include a powertrain control module (PCM) 180 configured to provide operate powertrain of the vehicle 102. For instance, the PCM 180 may be configured to start the vehicle responsive to receiving a command from the mobile device 128 via the TCU 170. The ECUs 168 may further include a HVAC controller 182 configured to control a climate system of the vehicle 102. For instance, the HVAC controller 182 may be configured to operate air-conditioning (AC), heating, seat ventilation/heating or the like to provide the user with a customized cabin condition. Each ECU 168 may be provided with or connected to sensors providing signals related to the operation of the specific ECU 168. For instance, The PCM 180 may be connected to a vehicle speed sensor (not shown) configured to provide signals of a driving speed of the vehicle. The HVAC controller 182 may be provided with a temperature sensor and a humidity sensor (not shown) configured to provide signals related to vehicle cabin temperature and humidity as a few non-limiting examples.

Although various ECUs 168 and the computing platform 104 are illustrated as individually connected to the in-vehicle network 166, the in-vehicle network 166 may be configured in different network topologies. In one example, the in-vehicle network 166 may be configured in a star network topology through a gateway controller 184, with each ECU 168 and the computing platform 104 operating as a node in communication with the gateway controller 184. The gateway controller 184 may include processing and local storage capabilities and may be configured to coordinate data communication between the various nodes as a central entity to which all other nodes are connected. A publish-subscribe communication protocol, such as MQTT, may be used by the gateway controller 184 to coordinate data communication on the in-vehicle network 166. In another example, the gateway function of the in-vehicle network 166 may be implemented via the computing platform 104, without utilizing a dedicated central unit such as the gateway controller 184.

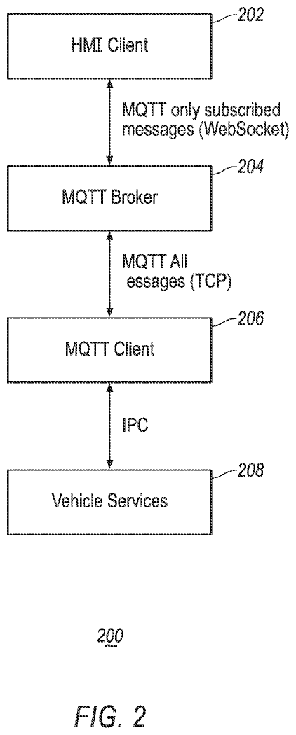

Referring to FIG. 2, an example block diagram of a vehicle communication system 200 of one embodiment of the present disclosure is illustrated. With continuing reference to FIG. 1, the vehicle communication system 200 may include an HMI client 202 configured to handle HMI features of the vehicle 102. For instance, the HMI client 202 may be implemented as a software application 108 configured to operate according to input received by the HMI controls 112 of the computing platform 104. The vehicle communication system 200 may further include an MQTT broker 204 configured to control the publish-subscribe operation of the vehicle network system 200. The MQTT broker 204 may communicate with the HMI client 202 via a web socket. Additionally or alternatively, Google® Protocol Buffers may be utilized by the MQTT broker 204 as a message payload structure. The MQTT broker 204 may also be in communication with an MQTT client 206 configured to receive/send messages from/to one or more vehicle services 208 performing various operations of the vehicle 102. As an example, the MQTT broker 204 and the MQTT client 206 may be collectively or individually implemented as software via the gateway controller 184. Alternatively, the MQTT broker 204 and the MQTT client 206 may be collectively or individually implemented as software via the computing platform 104. The vehicle services 208 may be associated with various ECUs 168 and configured to perform various operations and communicate via the vehicle communication system 200.

The following is a general example of the operations of the vehicle communication system 200 utilizing a publish-subscribe network protocol. The vehicle services 208 may publish a message to vehicle communication system 200 via the in-vehicle network 166, and the message may be sent to the MQTT client 206 via a platform-specific proprietary inter-process communication (IPC) mechanism. Responsive to receiving the message, the MQTT client 206 may process and convert the message into a transmission control protocol (TCP) message, and may send the TCP message to the MQTT broker 204 for distribution. It is noted that, the MQTT client 206 may be configured to send all messages that are received and processed to the MQTT broker 204, as the MQTT client 206 may not be configured to control message subscriptions.

The HMI client 202 may be subscribed to one or more of these topics via the MQTT broker 204. The messages received by the MQTT broker 204 may be associated with these topics based on the vehicle services 208 from which the messages originated, and/or based on the information included within the messages. Responsive to receiving the message from the MQTT client 206, the MQTT broker 204 may identify the topic of the message and may post the message the topic for the HMI client 202 if the topic is subscribed to. The MQTT broker 204 may be configured to send the message to the HMI client 202 via a web socket. It is noted that the HMI client 202 is merely used as an example in the present embodiment and other client services may be in communication with the MQTT broker 204 for various operations.

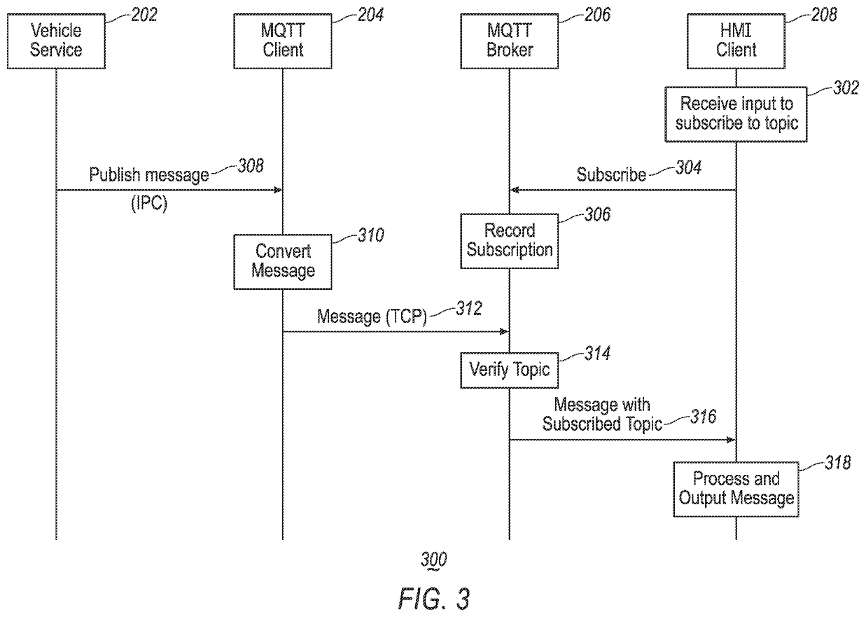

Referring to FIG. 3, an example flow diagram for a process 300 of the vehicle communication system of one embodiment of the present disclosure. With continuing reference to FIGS. 1 and 2, responsive to receiving an input instructing to subscribe to a topic at operation 302, the HMI client 208 sends a subscription request to the MQTT broker 206 at operation 304. The subscription input received at operation 302 may be originated from various sources. For instance, a vehicle user (not shown) may intent to obtain vehicle power mode settings from the PCM 180 by subscribing to the power mode topic via the HMI controls 112. Additionally or alternatively, the user may subscribe to vehicle topics by operating the mobile device 128 wirelessly connected to the computing platform 104 via the connection 130. Responsive to receiving the user input via the mobile device 128, the wireless transceiver 132 may send the request via the HMI controls 112 to subscribe to the topic. In another example, the input may be made remotely from the server 178 to instruct the HMI client to subscribe to one or more new topics. Such situation may happen responsive to an update made to vehicle applications 108 to support new features enabled by data from the ECUs 168. Responsive to receiving the subscription request, the MQTT broker 206 record the subscription and associate the subscribed topic with the HMI client 208.

At operation 308, a vehicle service 202 publishes a message onto the in-vehicle network 166. For instance, the vehicle server 202 may be running on an ECU 168 and publishes the message in IPC format or other forms of raw data with or without overhead. the message includes information indicative of one or more topics with which the message is associated. For instance, a vehicle service 202 at the PCM 180 may publish messages having topics such as “speed”, “gear”, “power mode” or the like. Similarly, a vehicle service 202 at the HVAC controller 182 may publish messages having topics related to the HVAC system such as “temperature”, “humidity” or the like. Responsive to receiving the message, at operation 310, the MQTT client 204 processes the message and converts the message into a format compliant with a predefined protocol. For instance, the MQTT client 204 may be configured to convert the message from the vehicle service 202 into a TCP-complaint message and send the converted message to the MQTT broker 206 for distribution based on the topic at operation 312. Responsive to receiving the message in TCP-compliant format, the MQTT broker 206 verifies the topic of the message as received and publishes the message to the topic as verified at operation 314. Responsive to verifying the HMI client 208 is subscribed to the topic of the message, the HMI client 208 requests and/or the MQTT broker 206 sends the message to HMI client 208 for processing and outputting at operation 318. For instance, the HMI client 208 may output the message via the display 114 and/or speaker 118. Additionally or alternatively, the HMI client 208 may be configured to output the message to the mobile device 128 via the wireless transceiver 132 or to the server 178 via the TCU 170.

The operations of process 300 may be applied to various situations. For instance, the user of the vehicle 102 may intend to access a radio tuner feature by operating the HMI controls 112 to subscribe to an appropriate topic. A topic may be configured into a topic tree using the following format:
hmi/{domain}/{type}/{signal}.
   Continuing with the above example, the HMI client 208 may subscribe to topics in the “hmi/tuner” topic domain in response to the user request to control the tuner. In the present example, the radio tuner of the vehicle 102 may be configured to support various radio transmissions such as AM, FM or the like. Therefore, the “hmi/tuner” topic domain may be further divided into various sub topic domains such as “hmi/tuner/am”, or “hmi/tuner/fm”. It is noted that the radio tuner feature topic is merely used as an example in the present embodiment. The following table illustrates some other non-exhaustive topic domains related to the vehicle communication system.

TABLE 1
Examples of vehicle topics.

| | | Related Controller |
|---|---|---|
| Topic | Domain Description | (non-exhaustive) |
| hmi/tuner | Radio tuner | Radio tuner controller |
| hmi/tuner/fm | | (not shown) |
| hmi/tuner/am | | |
| hmi/tuner/dab | | |
| hmi/lighting | 360 degree lighting and | Body control module (not |
| | other lighting topics | shown) |
| hmi/applink | Applink | Wireless transceiver |
| hmi/bluetooth | Bluetooth | Bluetooth controller |
| hmi/climate | Climate | HVAC |
| hmi/driverassist | Driver assistance | PCM |
| hmi/ev | Electrification | battery controller (not |
| | | shown) |
| hmi/ea | Emergency assistance | TCU |
| hmi/fei | Fob-free ignition, phone | PCM, TCU, wireless |
| | as key | transceiver |
| hmi/media | Media player | video controller, audio |
| | | controller |
| hmi/nav | Navigation | Navigation controller 122, |
| | | GNSS 124 |
| hmi/phone | Phone related topics | wireless transceiver, NFC, |
| | | RFID, Wi-Fi, Bluetooth |
| hmi/rvc | Rear view camera | Exterior camera (not |
| | | shown) |
| hmi/sirius | Sirius XM related topics | Radio controller |
| hmi/trafficcenter | Traffic center | TCU, GNSS, Navigation |
| | | controller |
| hmi/voice | Voice command | Audio controller |
| | messages | |
| hmi/audio | Audio related messages | Audio controller |
| hmi/language | Language/localization | GNSS, system-related |
| | related messages | controllers |
| hmi/provisioning | Network provisioning | TCU, wireless transceiver |
| | related messages | |
| hmi/software- | Software update | TCU, Wi-Fi |
| update | related messages | |
| hmi/system- | System maintenance | PCM |
| maintenance | related messages | |
| hmi/time | System time/clock | System-related controllers |
| | related messages | |
| hmi/setting | Vehicle settings | System-related controllers |

Each vehicle service 202 may be associated with one or more topic domains illustrated or not illustrated in above Table 1. Each domain may be further associated with one or more topic types. In other words, when a vehicle server 202 publishes a message related to a topic domain, the message may be of one of multiple topic types. For instance, the topic type may include a value type indicative of value data associated with the message from the vehicle service 202. The data value topics published by the vehicle service 202 may be retained in the MQTT broker 206 and read by an application at any time. For instance, a topic “hmi/climate/value/auto-air-flow-mode” may be a value topic in the climate domain for auto airflow mode. Being a value type topic, the MQTT broker 206 retains this topic for current and future access by applications/clients. The MQTT broker 206 may be configured to retain the value type topic indefinitely until a new value is published. Alternatively, the MQTT broker 206 may be configured to store the value for a predefined period of time (e.g., one hour) to free up storage space after the period expires. Continuing with the above radio tuner example, the topic from the radio tuner domain may be “hmi/tuner/fm/87.6” which indicates the value of radio tuner. The HMI client 208 may access the value topic at any time.

In addition to the value type topic, a message may be of an update topic type. The update topic type may be a momentary topic published by a vehicle service 202 to notify a change of status. The MQTT broker 206 may be configured not to retain the update topic and therefore the update topic may be only available to clients that are currently listening when the topic is published. For instance, a topic “hmi/rvc/update/system-not-available” may be an update topic in the rear-view camera domain to notify the feature is not available. Being an update type, the topic is published by the vehicle service 202 and subscribed to by any application related to such feature. Although not retained in the MQTT broker 206, the topic may be available for query to the corresponding vehicle service 202.

The topic type may further include an event topic type. The event topic type may be a momentary topic published by a vehicle service 202 to notify a change in system state. The event topic type is generally not retained by the MQTT broker 206 and only available to specific client (e.g., the HMI client 208). For instance, the topic “hmi/phone/event/set-do-not-disturb” may be an event topic in the phone domain to notify the hmi client 208 to change the do not disturb value. Being an event type, this topic may be published by the vehicle service 202 in response to a user event (e.g., user input).

Continuing with the above radio tuner example, responsive to subscribing to the “hmi/tuner” domain, the MQTT broker 206 record the subscription and the HMI client 208 may have access to all current and past topics in the domain (since the domain is the value type). When the radio tuner is adjusted such as radio tuned to another channel/frequency, the vehicle service 202 may publish a message under the radio tuner domain with the new configuration value (e.g., “hmi/tuner/fm103.9”). The message may be published onto the in-vehicle network 166 in an IPC format which may not be readable by the HMI client 208. The MQTT client 204 may receive the message and convert the message to a format that is readable by the HMI client 208. For instance, the MQTT client 204 may convert the message (e.g., from CAN) into a TCP format and transfer the message as converted to the MQTT broker for distribution. Responsive to receiving the message, the MQTT broker 206 may process the message to determine a topic domain of the message. In the present example, the topic domain is “hmi/tuner”. Responsive to determining the topic domain, the MQTT broker 206 may identify all clients subscribed to the “hmi/tuner” domain to send out the message. In the present example, the HMI client 208 is subscribed to such domain. Therefore, the MQTT broker 206 may publish the message to the topic for retrieval by the HMI client 208 for output. Responsive to receiving the message, the HMI client 208 may output the new value of the radio tuner via the display 114 to notify the user about the change.

Additionally, the operations of 300 may be implemented reversely to publish a message from the HMI client 208 to the vehicle service 202. For instance, responsive to a user input via the HMI client 208 instructing to tune to another radio channel, the HMI client 208 may publish a message to the MQTT broker 206 via the in-vehicle network 166. Responsive to receiving the message from the HMI client 208, the MQTT broker 206 may process and identify the topic of the message. In response the MQTT broker 206 sends the message to the vehicle service 202 identified by the topic via the MTQQ client 204 for format conversion. With continuing reference to the above radio tuning example, the MQTT broker may send the message to the radio controller to update the channel value. Responsive to receiving the message, the radio controller may change the tuning to a new channel using the value of the message.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle, comprising:
a human-machine interface (HMI) controller configured to provide an in-vehicle HMI;
an electronic control unit (ECU), configured to control a vehicle operation; and
a gateway controller connected to the HMI controller and to the ECU via an in-vehicle network, the gateway controller configured to
responsive to receiving a request to subscribe to a topic from the HMI controller, subscribe the HMI controller to the topic,
responsive to receiving a message in a first format sent from the ECU via the in-vehicle network, convert the message into a second format and process the message to identify a message topic associated with the message,
publish the message to the message topic, and
responsive to verifying the HMI controller is subscribed to the message topic, send the message in the second format to the HMI controller.

2. The vehicle of claim 1, wherein the gateway controller is further configured to:
responsive to receiving a second message in the second format sent from the HMI controller, identify the second message topic of the second message;
publish the message to the second message topic;
identify a second ECU subscribed to the second message topic;
convert the second message from the second format to the first format; and
send the second message to the second ECU in the first format.

3. The vehicle of claim 1, wherein the HMI controller is further configured to:
responsive to receiving the message from the gateway controller, output content of the message via a display.

4. The vehicle of claim 1, wherein the HMI controller is further configured to:
communicate with a mobile device via a wireless transceiver through a wireless link; and
send the message to the mobile device via the wireless link.

5. The vehicle of claim 4, wherein the HMI controller is further configured to:
receive a subscription input originated from the mobile device via the wireless link.

6. The vehicle of claim 1, wherein the HMI controller is further configured to:
communicate with a remote server via a telematics control unit (TCU) through a cellular connection; and
send the message to the remote server via the cellular connection.

7. The vehicle of claim 6, wherein the HMI controller is further configured to
receive a subscription input originated from the remote server via the cellular connection.

8. The vehicle of claim 1, wherein the message may be associated with at one of the following types: value, update, or event.

9. The vehicle of claim 8, wherein the gateway controller is further programmed to:
responsive to a value type message, retain the message in a gateway storage for a predefined period of time; and
responsive to the HMI controller subscribed to the topic, load the message from the gateway storage to send to the HMI controller.

10. The vehicle of claim 9, wherein the gateway controller is further programmed to:
responsive to an update or event type message, send the message to the HMI controller without retaining the message in the gateway storage.

11. The vehicle of claim 10, wherein the gateway controller is further programmed to:
responsive to receiving, from the HMI controller, a request for value of an update or event type topic which is not retained in the gateway storage, query the ECU about a current value of the topic requested.

12. A method for a vehicle, comprising:
responsive to receiving a request for subscribing to a user topic from a user client, associating the user client with the user topic;
responsive to detecting a message in a first format published by a vehicle service onto an in-vehicle network, converting the message into a second format via a gateway client;
processing the message in the second format to identify a message topic via a broker using MQ telemetry transport (MQTT) protocol; and
responsive to verifying the user topic matches message topic, send the message in the second format to the user client.

13. The method of claim 12, further comprising:
sending the message in the second format to a mobile device wirelessly connected to the vehicle.

14. The method of claim 12, further comprising:
sending the message to a remote server via a telematics control unit (TCU) through a cellular connection.

15. The method of claim 12, further comprising:
outputting a content of the message via an audio speaker.

16. The method of claim 12, further comprising:
storing the message in the second format in a storage associated with the broker for a predefined period of time.

17. The method of claim 12, further comprising:
responsive to receiving, from the user client, a request for value of second topic, query the vehicle service about a current value of the topic requested via the broker.

18. A non-transitory computer-readable storage medium comprising instructions, when executed by processor of a vehicle, make the vehicle to:
responsive to receiving a request for subscribing to a topic from a human-machine interface (HMI) controller, subscribe the HMI controller to the topic,
responsive to receiving a message in a first format published from an electronic control unit (ECU) via an in-vehicle network, convert the message into a second format and process the message to identify a message topic associated with the message,
responsive to verifying the topic the HMI controller subscribed to matches the message topic, send the message in the second format to the HMI controller, and
send the message in the second format to a mobile device via a wireless link.
